(19) United States
(12) Patent Application Publication
(10) Pub. No.: US 2004/0257621 A1
(43) Pub. Date: Dec. 23, 2004

(54) Method, apparatus, and program for image processing capable of producing high-quality achromatic colored output image, and medium storing the program

(76) Inventor: Hiroshi Ishihara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/816,878

(22) Filed: Apr. 5, 2004

(30) Foreign Application Priority Data
Apr. 11, 2003 (JP) 2003-108018

(51) Int. Cl. H04N 1/56; H04N 1/60

(52) U.S. Cl. 358/2.1; 358/518

(57) ABSTRACT

A method, apparatus, and program of image processing for generating graphics data according to picture description instructions based on original image data of full-color, and a medium for storing the program. The method, apparatus, and program include a chromatic tester, an obtainer, a color converter, and a converting condition designator. The chromatic tester determines whether a pixel of the original image data is chromatic or achromatic. The obtainer obtains an image property of the pixel. The color converter converts the original image data into CMYK data for printing according to a predetermined converting condition. The converting condition designator designates a type of the predetermined converting condition for the pixel determined as achromatic by the chromatic tester according to the image property obtained by the obtainer.

This application claims priority to Japanese patent application No. 2003-108018 filed on Apr. 11, 2003 in the Japan Patent Office, the entire contents of which are incorporated by reference herein.

### BACKGROUND OF THE INVENTION

1. Field of the Invention

The present invention relates to image data processing, and more particularly to a method, apparatus, and program for image processing, and a medium storing the program, capable of selecting a proper color converting condition for an achromatic pixel, thereby increasing the quality of output image.

2. Discussion of the Background

An image processing apparatus, like a printer, for example, for generating graphic data according to picture description instructions (PDI) based on full-colored image data carries out, in a process of generating graphic data from RGB data representing an original image, color conversion to generate CMYK data used for color printing. For the color conversion, there has been used two converting methods of processing achromatic color, i.e., gray color including white and black colors, depending on a drawing method. In a case of performing color printing of a page including text, graphs, or photographs, like a business document, for example, it is preferable that the gray color used in text or a graph is printed with K (black) colored material, and the gray color used in a photograph image is printed with mixed material of CMYK (cyan, magenta, yellow, and black) colors. Accordingly, a type of a conversion is determined between using a K monochrome color and CMYK four colors, corresponding to a type of the graphics. When gray colored graphics in text or a graph is printed with four-colored material, it tends to be too thick. Consequently, in such a case, a laser printer may introduce an undesirable effect like blur caused by toner shattering, while an ink jet printer may introduce paper misdirection or glaze caused by usage of an abundance of ink, for example. On the other hand, printing graphics in the photograph image generates other problems as it needs to be processed with consideration of gradation. When a gray colored area is printed with the K monochrome material, a boundary of the gray colored area and a chromatic colored area may become too obvious to be discriminated and patchy, thereby decreasing the quality of the image. This is because that the two types of areas are printed with different types of materials, that is, the K monochrome and the CMYK four colors.

Japanese Patent Laid-Open Application Publication No. 9-27915 and Japanese Patent Laid-Open Application Publication No. 7-184075 describe techniques for eliminating deterioration of the image quality caused by the above reasons. Japanese Patent Laid-Open Application Publication No. 9-27915 describes a technique which determines whether an area is gray colored or not by checking color components in an image area of an identical color in image data to be converted, and adopts gray processing performing color conversion with a K monochrome converting condition to the data determined as gray. It is also described that when a type of the image area (graphics object) is determined as other than text, the gray processing is not adopted to the area. In addition, it is described that a criterion of the check can be changed depending on the type of the area. In the above technique described in Japanese Patent Laid-Open Application Publication No. 9-27915, for example, once the type of the area of the image data to be processed is known, it is possible to perform, as a corresponding process to the type of the area, the gray processing on text data using the K monochrome color only. It is able to identify a type of an object, like text, graph, or photograph, on a language level for page-description language (PDL) for printers from various manufacturers based on Windows graphical device interface (GDI), PostScript, for instance. It is therefore possible to adopt the gray process, that is, to perform color conversion with the K monochrome converting condition to the area in accordance with its identified type, thereby reducing deterioration of the image generally caused by the gray process as described in the above.

Japanese Patent Laid-Open Application Publication No. 7-184075 allows to change a threshold value used in monochrome determination for each component data of an input colored image in order to adopt an optimum criterion for determining a type of an original document, thereby generating a high-quality image.

The above techniques need to identify a data type in order to determine a type of an area to be processed. The techniques do not intend to handle full colored image data, for example, image data from a digital camera, or image data generated with a scanner by scanning original data including mixed materials of text, photographs, or graphics, without any information for identifying a type of contents. It is preferable that the image data without any type identification to converting it into graphics data, CMYK data, for example, is processed with an achromatic processing, in order to prevent deterioration of the image quality. It is also desirable to provide the above function in a simple method, without introducing additional hardware like an Application-Specific Integrated Circuit (ASIC) chip.

### SUMMARY OF THE INVENTION

In view of the foregoing, it is an object of the present invention to provide a novel image processing apparatus which improves the quality of an output image including chromatic color.

Another object of the present invention is to provide a novel image processing method which improves the quality of an output image including chromatic color.

Another object of the present invention is to provide a novel computer program product stored on a computer readable storage medium which, when run on an image processing apparatus, carries out an image processing method which improves the quality of an output image including chromatic color.

Another object of the present invention is to provide a novel computer readable medium that stores computer instructions for performing an image processing method which improves the quality of an output image including chromatic color.

Another object of the present invention is to provide a novel printer controller installed in an image forming apparatus and storing computer instructions for performing an image processing method which improves the quality of an output image including chromatic color.

Another object of the present invention is to provide a novel printer driver installed in a hosting computer and storing computer instructions for performing an image processing method which improves the quality of an output image including chromatic color.

To achieve these and other objects, in one example, the present invention provides a novel image processing apparatus for generating graphics data according to picture description instructions based on original image data of full color including a chromatic tester, an obtainer, a color converter, and a converting condition designator. The chromatic tester determines whether a pixel of the original image data is chromatic or achromatic. The obtainer obtains an image property of the pixel. The color converter converts the original image data into CMYK data for printing according to a predetermined converting condition. The converting condition designator designates a type of the predetermined converting condition for the pixel determined as achromatic by the chromatic tester according to the image property obtained by the obtainer.

The chromatic tester may be configured to determine the pixel as achromatic when values of RGB color components are identical to each other.

The chromatic tester may be configured to determine the pixel as achromatic when differences in data value among RGB components of the pixel fall within respective predetermined threshold values.

The predetermined condition used for the pixel determined as achromatic may be configured to be any one of a K monochrome converting condition using a black color and a normal converting condition using cyan, magenta, yellow, and black colors.

The obtainer may be configured to check pixels in a predetermined area in the original image data to obtain the image property of the pixel.

The image property of the pixel may be configured to be either one of a first image property of including any chromatic pixel in the pixels in the predetermined area and a second property of not including any chromatic pixel in the pixels in the predetermined area, and the converting condition designator designates the K monochrome converting condition to the pixel having the first image property.

The predetermined area may be configured to have a predetermined number of sequential pixels immediately preceding the pixel in a main scanning direction.

The predetermined area may be configured to have a predetermined number of sequential pixels immediately succeeding the pixel in the main scanning direction.

The predetermined area may be configured to have a predetermined number of sequential pixels immediately preceding and succeeding the pixel in the main scanning direction.

The predetermined area may be configured to be formed with an m-by-n matrix surrounding the pixel, m and n being positive integer values greater than zero.

Further, in one embodiment, a novel image processing method for generating graphics data according to picture description instructions based on original image data of full color includes the steps of determining, obtaining, designating, and converting. The determining step determines whether a pixel of the original image data is chromatic or achromatic. The obtaining step obtains an image property of the pixel. The designating step designates a type of a predetermined converting condition for the pixel determined as achromatic by the determining step according to the image property obtained in the obtaining step. The converting step converts the original image data into CMYK data according to the predetermined converting condition.

Further, in one embodiment, a computer program product stored on a computer readable storage medium run on an image processing apparatus executes an image processing method, and a computer program product stored on a computer readable storage medium run on the image processing apparatus executes the image processing method, as described above.

Further, in one embodiment, a computer readable medium storing computer instructions performs an image processing method, and a computer readable medium storing computer instructions performs an image processing method, as described above.

Further, in one embodiment, a printer controller in an image forming apparatus storing computer instructions performs an image processing method, and a printer controller storing computer instructions performs an image processing. method, as described above.

Further, in one embodiment, a printer driver in a host computer storing computer instructions performs an image processing method, and a printer driver storing computer instructions performs an image processing method, as described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram showing an exemplary configuration of a printer according to an embodiment of the present invention;

FIG. 2 is a diagram illustrating a first principle for determining a converting condition by checking whether a pixel has a property of a photographic image;

FIG. 3 is a diagram illustrating a second principle for determining the converting condition by checking whether the pixel has the property of the photographic image;

FIG. 4 is a diagram illustrating a third principle for determining the converting condition by checking whether the pixel has the property of the photographic image;

FIG. 5 is a flowchart showing an exemplary procedure of image data processing according to exemplary embodiment of the present invention;

FIG. 6 is a flowchart showing detailed steps of a chromatic determination step in the exemplary procedure shown in FIG. 5;

FIG. 7 is a flowchart showing detailed steps of a photograph image property checking step in the exemplary procedure shown in FIG. 5; and

FIG. 8 is a flowchart showing detailed steps of a color converting condition designating step in the exemplary procedure shown in FIG. 5.

### DETAILED DESCRIPTION OF PREFERRED EMBODIMENTS

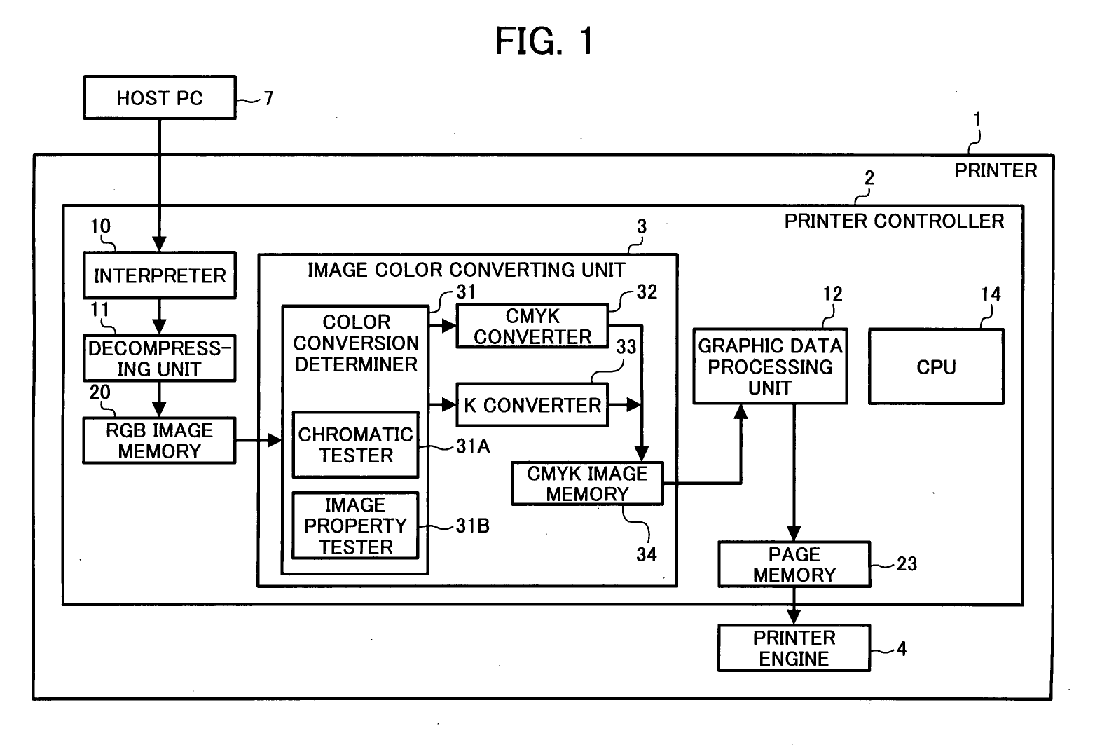

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, a printer 1 as an image processing apparatus according to an exemplary embodiment of the present invention is described. In FIG. 1, the printer 1 includes a printer controller 2 and a printer engine 4. The printer controller 2 includes an image color converter 3, an interpreter 10, a decompressing unit 11, a graphic data processing unit 12, a CPU 14, an RGB image memory 20, and a page memory 23. The image color converting unit 3 includes a color conversion determiner 31, a CMYK converter 32, a K converter 33, and a CMYK image memory 34. The color conversion determiner 31 includes a chromatic tester 31A and an image property tester 31B. FIG. 1 also shows a host PC 7 outside the printer 1.

In a process of generating graphics data according to picture description instructions (PDI) based on full-colored image data, the embodiments described below enable to select a color converting condition, to be applied to a target pixel determined as achromatic, from a K monochrome converting condition using a K (black) color and a normal converting condition using CMYK (cyan, magenta, yellow, and black) four colors. The converting condition is selected according to a type of the target pixel of original source image data, thereby increasing the quality of the output image. The embodiments use a generalized printer system, that is, a system including the printer 1 for carrying out printing operations based on a printing command sent from a hosting computer, in order to describe examples of graphics processing according to the present invention. In order to process graphics data at the side of the printer, the printer controller 2 may take charge of it as in some of existing laser printers. Alternatively, a printer driver may be installed with functions necessary for performing the above process at the side of the hosting computer, as in some of existing ink-jet printers. In cases of using the printer controller 2 or the printer driver to perform the process, a computer for driving them, i.e., a central processing unit (CPU), may include a program for carrying out required functions.

The present embodiment describes a basic method of specifying a type of a color conversion of achromatic colored pixel, aiming to improve the quality of an output image to be printed. In the color conversion of achromatic color, a converting condition is selected between the K monochromatic converting condition and the normal converting condition using CMYK four colors, according to a characteristic of a pixel in original image data. A type of printed material handled with the embodiment is a business document including mixed materials of text, graphics, photographs, and so forth, for example. The embodiment aims to improve the quality of such a document by printing black colored text or a ruled line of the graph with K monochrome color in order to make its appearance clear, and printing gray colored pixels in a part of a photograph image with CMYK colors in order to keep gradation seriality of the pixel to ambient pixels. The printer controller 2 in the printer 1 shown in FIG. 1 receives a printing command from a host device, the host PC 7 in this example, processes data as needed in order to perform printing operation according to the printing command, and controls several units in the printer 1. The printer engine 4 receives image data output from the printer controller 2 to print out the image onto a medium such as a sheet of paper. In order to process the input printing command to generate graphics data to be output to the printer engine 4, the printer controller 2 is provided with the interpreter 10, the decompressing unit 11, the image color converting unit 3, and the graphics data processing unit 12. The printer controller 2 is also provided, in order to store data during data processing steps, with the RGB image memory 20, the CMYK image memory 34, the page memory 23, and the CPU 14. In a case that hardware implements the interpreter 10, the decompressing unit 11, the image color converting unit 3, and the graphics data processing unit 12, these components are controlled by the CPU 14. When software implements the interpreter 10, the decompressing unit 11, the image color converting unit 3, and the graphic data processing unit 12, the CPU 14 works to drive the software.

Operations of each component shown in FIG. 1 will now be described according to a procedure of processing the image data. The host PC 7 generates colored image data, transmits a printing command based on the data in the PDL format, for example, to the printer controller 2 of the printer 1. In this exemplary embodiment, colored image data generated in the host PC 7 as the original source data is in an RGB format. A printer driver (not shown) in the host PC 7 transmits the image data in the RGB format as it is without performing any conversion into a CMYK format. The colored image data input into the printer controller 2 as the printing command is further input into the interpreter 10 for decoding PDL data or format to transformed into intermediate data-which is transferred to the decompressing unit 11. The decompressing unit 11 sequentially processes the intermediate data, like a decoding of compressed color image data as needed, thereby expanding the intermediate data into a bitmap format and storing it into the RGB image memory 20. The RGB image data is input into the image color converting unit 3 to be converted into the CMYK format for printing. The image color converting unit 3 is able to use several converting conditions. A converting condition to be used is selected according to designation. In the image color converting unit 3, the color conversion determiner 31 determines, for the RGB bitmap data decompressed and stored in the RGB image memory 20, a color converting condition applied by pixel. Detailed functions of the color conversion determiner 31 will be described later.

In this embodiment, two types of color converting conditions are possible as follows; first, a K monochrome converting condition performed with the K converter 33 using the K color without CMY colors, and second, a normal converting condition performed with the CMYK converter 32 using CMYK four colors. The K monochrome converting condition is applied when an RGB of input pixel is determined as achromatic. An output of the K monochrome converting condition is printed with K colored material alone. The converting condition adopts “K=1.0-R” and “C=M=Y=0.0”, for example. In the CMYK converting condition which uses materials of CMYK four colors for printing, each color may be calculated by using a method generally known as black generation (BG) and/or under color removal (UCR). In a color conversion of a pixel determined as achromatic, either one of the K monochrome converting condition or the CMYK four colors converting condition is applied according to the specification from the color conversion determiner 31. After the color conversion, the CMYK image data is temporarily stored into the CMYK image memory 34. The graphics data processing unit 12 uses the data in the CMYK image memory 34 to expand graphics by each of the CMYK colors and write resultant data into the page memory 23. Upon completion of processing the PDI in one page according to the above described graphics processing, the data stored in the page memory 23 is sent to the printer engine 4 and the image is printed out onto a recording medium like a sheet of paper.

The detailed functions of the color conversion determiner 31 will now be described. The color conversion determiner 31 determines which converting condition is applied between the K monochrome and the CMYK four colors for an achromatic colored data to be converted by pixel, and causes the K converter 33 or the CMYK converter 32, depending on determination result, to convert the data. The color conversion determiner 31 in this embodiment carries out two checking steps. First step is achromatic checking to determine whether the pixel is achromatic or chromatic, performed with the chromatic tester 31A. Second step is, if the pixel is determined as achromatic, checking whether the pixel has a characteristic of a pixel in a photograph image, performed with the image property tester 31B. According to the results of the above checking steps, the color conversion determiner 31 assigns the CMYK four colors conversion to the pixel when the pixel is achromatic and has the characteristic of the photograph image. When the pixel is achromatic but do not have the characteristic of the photograph image, the color conversion determiner 31 assigns the K monochrome converting conversion to the pixel. When the pixel is determined as chromatic, the CMYK four colors converting condition is immediately applied. Since the chromatic checking needs to be performed on each pixel, image data having RGB components corresponding to each pixel, like an image generated with a digital camera or a scanner, can be processed without any difficulty. On the other hand, it is unable for the chromatic checking to directly process image data with no pixel-based data, like text data in PDL format or raster graphics data. To solve the problem, a drawing object like text or graphics specified with the PDI is decompressed based on color specification data for the object into the bitmap format before the chromatic checking is performed on a pixel basis, as described above.

In the chromatic checking, a pixel not satisfying a criterion for an achromatic color, i.e., a gray color including white and black colors, is determined as achromatic. When the pixel cannot be determined as achromatic, it is determined as chromatic. In this embodiment, the criterion for the chromatic color is whether values of components of input RGB are identical, i.e., whether “R=G=B” is satisfied or not. When the pixel is determined as achromatic by satisfying “R=G=B”, the pixel is further examined whether it has the characteristic of the photographic image. Information necessary for this examination is easily obtained when an image type is specified and indicates that the data is the photograph image. For example, it is possible to have a user operate a key or the like for specifying the type of the image data, thereby detecting the image type according to an operational input. It is also possible to detect whether the pixel needs to be processed as photograph data by examining area information for a drawing object indicated in the PDI. This can be examined by checking for a specification of a photograph object in a decoding result of the PDI which is generally used and described in PDL, since the PDI is expected to include the drawing object of text, graphics, or a photograph image.

Another embodiment based on the previous embodiment will now be described. The previous embodiment determines a pixel as achromatic when values of RGB components are identical satisfying the condition “R=G=B”, i.e., the pixel has no color saturation. According to this criterion, however, very small color saturation unrecognizable under human eyes causes the pixel to be determined as chromatic. For example, color calculation may have an error which may generate micro color saturation in a pixel which is originally achromatic. When such a pixel exists in a gradation area, the pixel is not regarded as achromatic but chromatic, thereby causing unevenness in output of the gradation area. In a case of using a format adopting a nonreversible compression method such as JPEG, it is also possible that a calculation process of compressing or decompressing causes alternation of the achromatic color into the chromatic color, thereby resulting in deterioration of the image quality. Furthermore, this undesirable interpretation may also occur in an image generated with the scanner or the digital camera. In normalizing RGB data with dependence of device characteristics into an integer value within a range of 0 to 255, for example, an achromatic original color may be regarded as the chromatic color. To avoid the above problem, the achromatic color checking is configured to regard a very small color range unrecognizable under human eyes as achromatic, thereby preventing deterioration and improving the image quality. In specific, a color of R≈G≈B including a micro chromatic color unrecognizable under human eyes is determined as achromatic. In order to make this determination, a threshold value is applied to a difference between optional two colors of the RGB. That is, the RGB is determined as achromatic when its components' values satisfy expressions |R-G|≦Trg, |G-B|≦Tgb, and |B-R|≦Tbr wherein Ttg, Tgb, and Tbr represent the respective threshold values. The above expressions are used in an example based on an assumption that values of Trg, Tgb, and Tbr differ from each other according to characteristics of devices. It is also possible, as a matter of course, to assume “Trg=Tgb=Tbr” for the sake of simplicity.

Another exemplary embodiment according to the present invention will now be described. In the first embodiment above, the CMYK four colors converting condition is specified to a pixel when the pixel is determined as achromatic and has the characteristic of the photograph image which may be detected by checking the drawing object specified in the PDI. However, since this method depends on an assumption that the PDI includes the specified drawing object, it is not applicable in other cases where the assumption does not hold. To improve this, the present embodiment provides a method of checking image data of a whole page of full-colored image data generated with the digital camera or the scanner without any specification of the drawing object for determining whether a pixel therein is for forming a photographic image or not. This embodiment checks a predetermined number of sequential pixels (n pixels) in a main scanning direction immediately preceding a target pixel in an original source image. When there exists any chromatic pixel in the n pixels, the target pixel is determined as a pixel of the photographic image. This method is suitable for raster original image data. In a case that the raster original image data is sequentially input as sequential pixels in the main scanning direction, and graphics data is generated by processing the sequential pixels, it is possible to check each pixel in the sequential pixels to determine whether the target pixel is for the photograph image or not with a simple configuration.

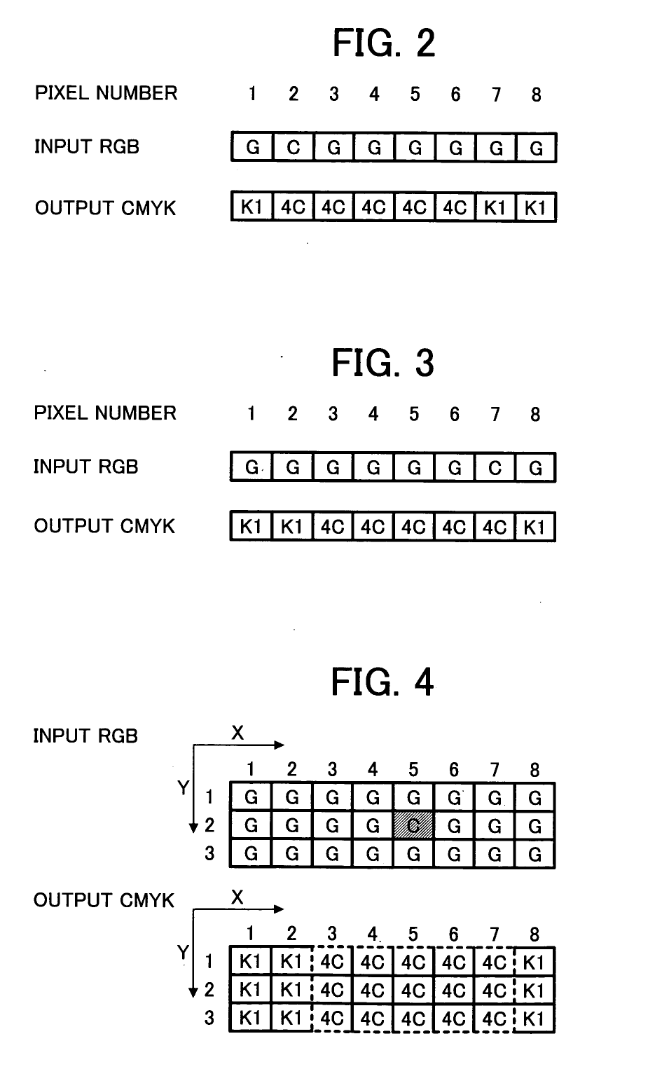

FIG. 2 shows an example of data including eight sequential pixels in the main scanning direction indicated with pixel numbers 1 through 8. An upper line shows exemplary results of the chromatic checking on input RGB pixels. G indicates that the pixel is achromatic, i.e., satisfies “R=G=B” or “R≈G≈B”, C indicates that the pixel is chromatic, i.e., not determined as achromatic. A bottom line shows color conversion conditions assigned to input pixels according to values in the upper line based on a certain principle. K1 indicates the K monochrome converting condition using “K=1.0-R” and “C=M=Y=0.0”, for example. 4C indicates the CMYK four colors converting condition using the BG/UCR to calculate four colors, for example. In this example, four preceding (past) pixels of the target pixel in the main scanning direction, n=4, in other words, are examined. In the example in FIG. 2, the 4C converting condition is applied when four pixels in the left of the target pixels include any chromatic pixel, and the K1 converting condition is applied when the four pixels includes no chromatic pixel. Specifically, since pixel 1 has achromatic (G) input RGB and has no chromatic (C) pixel in four past pixels, the K1 is applied for a conversion of the pixel 1. As an input of pixel 2 is chromatic (C), the 4C is immediately applied for a conversion of the pixel 2. Pixel 3 is achromatic (G) and have a chromatic (C) pixel, the pixel 2, namely, in preceding four pixels, so that the 4C converting condition is applied for its conversion. Checking results of pixels 4, 5, and 6 are similar to a result of the pixel 3. Since pixel 7 is achromatic (G) and has no C pixel in past four pixels, the pixel 7 is converted with the K1 converting condition. Checking result of pixel 8 is similar to a result of the pixel 7. According to the above principle, the CMYK four colors converting condition is specified to pixels regarded as forming the photograph image, that is, the pixels 3, 4, 5, and 6 in the above example. According to this principle, when all input RGB in the image data are G, all output CMYK thereof is converted with the K1 converting condition.

Another exemplary embodiment according to the present invention will now be described. This embodiment provides a method of checking a pixel in image data of a whole page of full colored data. The image data is generated with the digital camera or the scanner, that is, does not have any specification of the drawing object for determining whether the pixel therein is the pixel for forming the photographic image to which the CMYK four colors converting condition needs to be specified. From this viewpoint, an object of this embodiment is similar to the one of the previous embodiment. This embodiment adopts a method of checking presence of the chromatic pixel in predetermined number of sequential pixels (n pixels) in the main scanning direction adjoining to the target pixel. This method checks immediately succeeding pixels to the target pixel, while the method in the previous embodiment checks the immediately preceding pixels. As the previous embodiment, this embodiment is also suitable for the raster original image data, allowing required checking operation with a simple configuration. Since this method checks succeeding pixels of the target pixel, the method additionally requires pre-reading of the input data. In some cases, the method may result in more effective output according to a condition of the input image.

FIG. 3 shows an example of data including eight sequential pixels in the main scanning direction indicated with pixel numbers 1 through 8. An upper line shows exemplary results of the chromatic checking on input RGB pixels. G indicates that the pixel is achromatic, i.e., satisfies “R=G=B” or “R≈G≈B”, C indicates that the pixel is chromatic, i.e., not determined as achromatic. A bottom line shows color conversion conditions assigned to input pixels according to values in the upper line based on a certain principle. K1 indicates the K monochrome converting condition using “K=1.0-R” and “C=M=Y=0.0”, for example. 4C indicates the CMYK four colors converting condition using the BG/UCR to calculate four colors, for example. In this example, four preceding (past) pixels of the target pixel in the main scanning direction, n=4, in other words, are examined. In the example in FIG. 3, the 4C converting condition is applied when four pixels in the right of the target pixels include any chromatic pixel, and the K1 converting condition is applied when the four pixels includes no chromatic pixel. Specifically, since pixel 1 has achromatic (G) input RGB and has no chromatic (C) pixel in four succeeding pixels, the K1 is applied for a conversion of the pixel 1. Checking result of pixel 2 is similar to a result of the pixel 1. Pixel 3 is achromatic (G) and have chromatic (C) pixel, the pixel 7, namely, in succeeding four pixels, so that the 4C converting condition is applied for its conversion. Checking results of pixels 4, 5, and 6 are similar to a result of the pixel 3. As an input of pixel 7 is chromatic (C), the 4C is immediately applied for a conversion of the pixel 2. Since pixel 8 is achromatic (G) and has no C pixel in succeeding four pixels, the pixel 8 is converted with the K1 converting condition. According to the above principle, the CMYK four colors converting condition is specified to pixels regarded as forming the photograph image, that is, the pixels 3, 4, 5, and 6 in the above example. According to this principle, when all input RGB in the image data are G, all output CMYK thereof is converted with the K1 converting condition. By applying this embodiment together with the previous embodiment, it is possible to cover a predetermined number of pixels both preceding and succeeding the target pixel in the main scanning direction, in checking for a chromatic colored pixel. A converting condition is specified to the pixel according to the procedure described above and the procedure in the previous embodiment.

Another exemplary embodiment according to the present invention will now be described. This embodiment provides a method of checking a pixel in image data of a whole page of full colored data. The image data is generated with the digital camera or the scanner, that is, does not have any specification of the drawing object for determining whether the pixel therein is the pixel for forming the photographic image to which the CMYK four colors converting condition needs to be specified. From this viewpoint, an object of this embodiment is similar to the ones of the two previous embodiments. This embodiment adopts, in a similar manner as the previous two embodiments, a method of checking presence of the chromatic pixel in predetermined number of sequential pixels (n pixels) surrounding the target pixel. While the method in the second previous embodiment checks the preceding pixels to the target pixel and the method in the previous embodiment checks succeeding pixels, this method checks pixels in a predetermined area, for example, a 5×3 matrix of pixels surrounding the target pixel. When any chromatic (C) pixel exists in the matrix, the CMYK four colors (4C) converting condition is applied to the target pixel. By expanding an area for achromatic checking to a matrix formed with pixels adjoining the target pixel, the method in the embodiment is able to provide more adequate determination compared with the methods in the previous two embodiments.

FIG. 4 shows an example data including sequential pixels in a main scanning direction X numbered with 1 through 8 and in a sub scanning direction Y numbered with 1 through 3. An upper matrix shows exemplary results of the chromatic checking on input RGB pixels. G indicates that the pixel is achromatic, i.e., satisfies “R=G=B” or “R≈G≈B”. C indicates that the pixel is chromatic, that is, the pixel is not determined as achromatic. In FIG. 4, the chromatic pixel exists at a coordinate of 5 and 2, a cell filled with hatching. A bottom matrix shows color conversion conditions for input pixels determined according to values in the upper line based on a certain principle. K1 indicates the K monochrome converting condition using “K=1.0-R” and “C=M=Y=0.0”, for example. 4C indicates the CMYK four colors converting condition using the BG/UCR to calculate four colors, for example. This embodiment adopts a principle that the chromatic checking is preformed on pixels in a matrix of 5×3 pixels surrounding the target pixel. The 4C conversion is applied to the target pixel when any chromatic pixel is found in the matrix, and the K1 conversion is applied when no chromatic pixel is found in the matrix. Specifically, in FIG. 4, a pixel at a coordinate of 5 and 2 is chromatic (C) and other pixels are achromatic (G). Accordingly, the 4C converting condition is applied to pixels having the C pixel (5,2) within surrounding 5×3 pixels, that is, pixels in an area indicated with a rectangle with dashed lines, i.e., (X,Y)=(3-7, 1-3). The K1 converting condition is applied to a pixel outside of the area since it does not have any chromatic (C) pixel within a surrounding 5×3 matrix. According to this principle, when all input RGB in the image data are G, all output CMYK thereof is converted with the K1 converting condition.

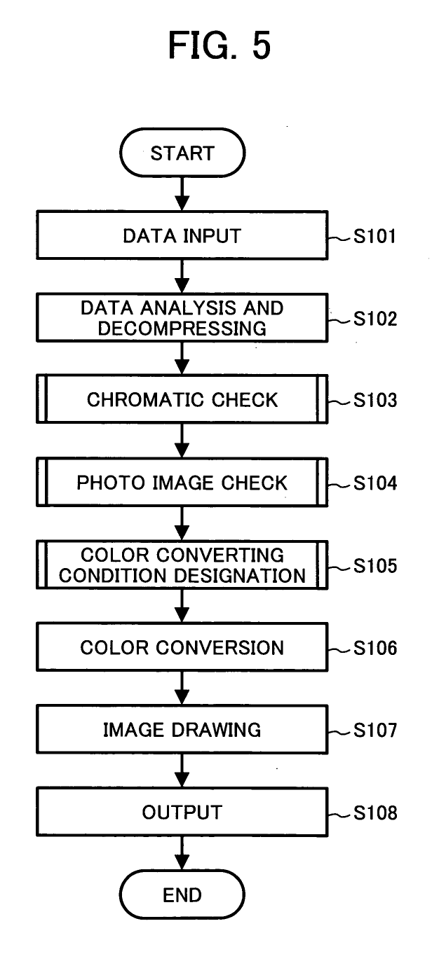

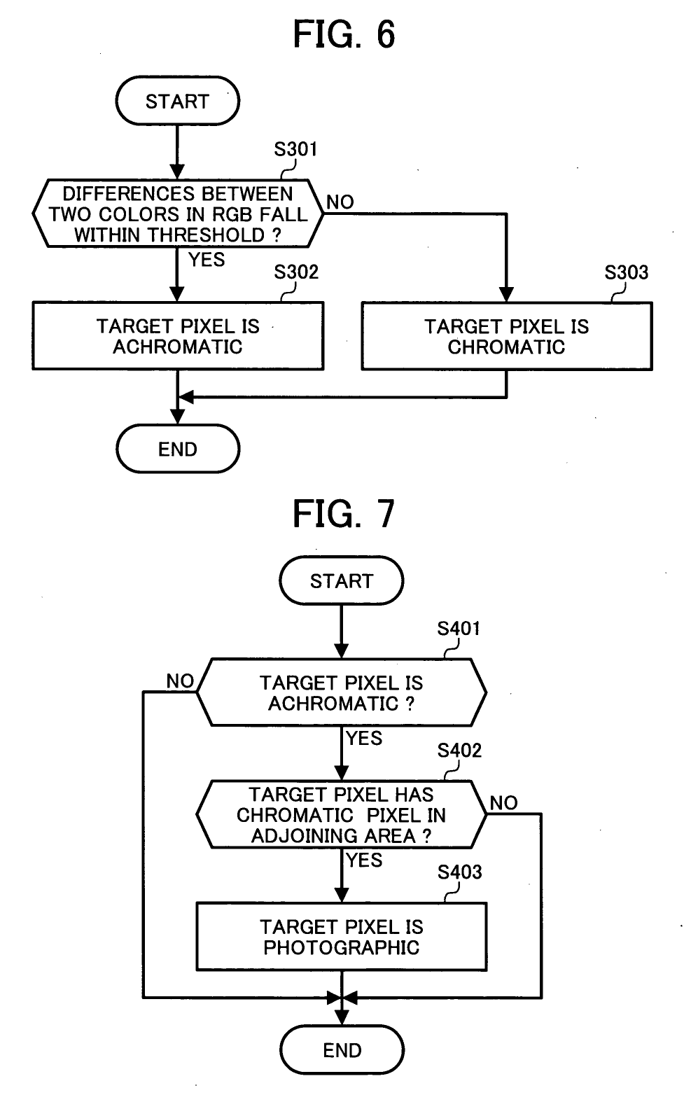

Referring now to FIGS. 5 through 8, a series of image processing operations according to the printer 1 of the present invention will now be described. FIG. 5 is a flowchart showing an exemplary procedure of image data processing according to the embodiment. In Step S101, the host PC 7 and the printer 1 initially establish communications via a communication interface, the printer controller 2 then launches a program for image data processing to receive the PDI from the host PC 7 to input data. The input PDI is such data described in a predetermined format or a language like PDL. Step S102 decodes the input data to generate graphics data as intermediate data, performing decompressing process, like decoding of color image data as necessary, on the intermediate data to generate RGB bitmap data, and temporarily stores the RGB bitmap data into the RGB image memory 20. The decompressing process of generating the bitmap data is necessary for a subsequent step of specifying a color converting condition to each pixel in the image data. In Step S103, the chromatic checking is performed on each of the pixels in the decompressed RGB bitmap data. In the chromatic checking, a pixel is determined as achromatic when its RGB components satisfy expressions |R-G|≦Trg, |G-B|≦Tgb, and |B-R|≦Tbr. The pixel is determined as chromatic when its RGB components do not satisfy the above expressions. The threshold values Trg, Tgb, and Tbr may be set to predetermined values larger than zero, so that a color including minimum chromatic color unrecognizable under human eyes can be regarded as achromatic. It is also possible to configure as “Trg=Tgb=Tbr=0” or “R=G=B”, naturally. FIG. 6 is a flowchart showing a subroutine of the chromatic checking step. Step S301 of the flowchart tests above expressions. When the expressions are satisfied, the result of Step S301 is YES and the operation goes to Step S302 to determine the target pixel as achromatic. When the result of Step S301 is NO, the operation goes to Step S303 to determine the target pixel as chromatic.

In Step S104, further checking is performed on the target pixel determined as achromatic to determine whether the target pixel has the characteristic of the pixel in the photographic image. When the target pixel determined as achromatic is further determined as the pixel of the photograph image, the CMYK four colors converting condition is applied to the target pixel. FIG. 7 is a flowchart showing a subroutine of Step S104 in FIG. 5, a photographic characteristic checking step. Step S401 checks whether the target pixel is achromatic or not by referring to the result of the chromatic checking step previously performed. When the target pixel is not achromatic, the result of Step S401 is NO and the operation exits this subroutine. When the target pixel is achromatic, the result of Step S401 is YES and the operation goes to Step S402 to check whether there exists any chromatic pixel in a predetermined area adjoining the target pixel. An embodiment of the photographic checking may vary according to the predetermined area which can be configured with the following four methods. A method A uses a predetermined number of sequential pixels immediately preceding to the target pixel in the main scanning direction, as shown in FIG. 2, for example. A method B uses a predetermined number of sequential pixels immediately succeeding to the target pixel in the main scanning direction, as shown in FIG. 3, for example. A method C uses a predetermined number of sequential pixels immediately preceding and succeeding to the target pixel in the main scanning direction, that is, a combination of the above two methods A and B. A method D uses a predetermined number of pixels surrounding the target pixel, as shown in FIG. 4, for example.

Among the above four methods, the method A handling preceding pixels of the target pixel has the simplest operations. The methods B, C, and D accordingly have less simple operations. Graphics data is basically processed in an inputting order, or in an order of lining in the main direction. The method B, C, and D need pre-reading in a line, and the method D further needs pre-reading of pixels in a next line to the target pixel, thereby requiring additional steps and making the process more complex. Among the four methods, accuracy appears in a reversal order of the simplicity. The method D can be the highest accuracy among the four methods in determining a photographic pixel as the method also checks pixels in adjoining lines of the target pixel. In addition to the pre-reading operation, the methods B, C, and D need to check a pixel in the predetermined area obtained with the pre-reading operation in advance to determine whether the pixel in the predetermined area is achromatic or not, that is, the chromatic checking process of Step S103. In FIG. 7, one of the four methods A through D is applied to specify the predetermined area of pixels to be checked. When there exists any chromatic pixel in the predetermined area, the result of Step S402 is YES and the operation goes to Step S403 to determine the target pixel is photographic and then exits the subroutine. When there exists no chromatic pixel in the predetermined area, the result of Step S402 is NO and the operation directly exits the subroutine.

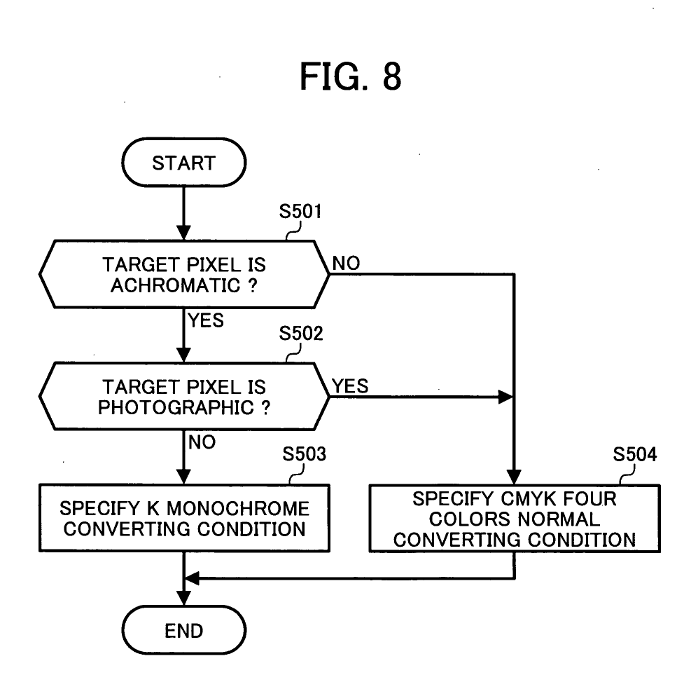

In Step S105, the color converting condition is specified to the target pixel according to the checking result in the photographic checking step. In this embodiment, one of the K monochrome converting condition or the CMYK four colors converting condition is specified to the target pixel determined as achromatic. Whether the target pixel has the photographic characteristic or not determines the type of converting condition to be specified. When the target pixel is achromatic and photographic, the CMYK four colors converting condition is specified, like other chromatic pixels in the photograph image. This keeps gradation seriality among a plurality of adjoining pixels, thereby preventing unevenness at a border of a gray colored area and a chromatic colored area nearly equal to gray. When the target pixel of chromatic color is in black colored text or black colored ruled lines of the graph, the K monochrome converting condition is applied in order to make an output image clear. FIG. 8 is a flowchart showing a subroutine of Step S105 in FIG. 5, a color converting condition designating step. Step S501 in FIG. 8 checks whether the target pixel is achromatic or not by referring to the result of the chromatic checking step previously performed. When the target pixel is not determined as achromatic in Step S103, Step S501 results NO and the operation goes to Step S504. In Step S504, since the target pixel is regarded as chromatic, the CMYK four colors converting condition normally used for the full-colored image data is designated to the target pixel. The operation then exits the subroutine. When the target pixel is achromatic, the result of Step S501 is YES and the operation goes to Step S502. Step S502 refers to the checking result of Step S104 to check whether the target pixel is photographic or not. When the target pixel is photographic, the result of Step S502 is YES and the operation goes to Step S504. In Step S504, the CMYK four colors converting condition is designated to the target pixel which is regarded as an achromatic colored pixel in the photograph image. The operation then exits the subroutine. When the target pixel is not regarded as photographic, the result of Step S502 is NO and the operation goes to Step S503. In Step S503, the K monochrome converting condition is designated to the target pixel which is regarded as achromatic, as a pixel in black text or ruled line of the graph, for example. The operation then exits the subroutine.

In Step S106 in FIG. 5, color conversion is performed on the target pixel according to the color converting condition designated in the Step S105. In the embodiment, the K monochrome converting condition uses the K color without CMY colors, that is, “K=1.0-R” and “C=M=Y=0.0”, for example. The CMYK four colors converting condition uses the general BG/UCR color conversion, for example. In Step S107, graphics data processing is performed on CMYK image data obtained by the color conversion by pixel in Step S106. The process includes decompressing of the CMYK image data into bitmap data by each color as writing the data generated into the page memory 23, using a dither pattern as a pseudo gradation process. Upon completion of processing the PDI in one page according to the above procedure, the operation goes to Step S108. Step S108 outputs data of each of the CMYK colors stored in the page memory 23 to the printer engine 4 to print out the data onto a recording medium like a sheet of paper. Then the graphics data processing terminates.

This invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. The present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that within the scope of the appended claims, the disclosure of this patent specification may be practiced otherwise than as specifically described herein.

What is claimed as new and desired to be second by Letters Patent of the United States is:

1. An image processing apparatus for generating graphics data according to picture description instructions based on original image data of full color, comprising:
a chromatic tester configured to determine whether a pixel of the original image data is chromatic or achromatic;
an obtainer configured to obtain an image property of the pixel;
a color converter configured to convert the original image data into CMYK data for printing according to a predetermined converting condition; and
a converting condition designator configured to designate a type of the predetermined converting condition for the pixel determined as achromatic by said chromatic tester according to the image property obtained by said obtainer.

2. The image processing apparatus according to claim 1, wherein said chromatic tester determines the pixel as achromatic when values of RGB color components are identical to each other.

3. The image processing apparatus according to claim 1, wherein said chromatic tester determines the pixel as achromatic when differences in data value among RGB components of the pixel fall within respective predetermined threshold values.

4. The image processing apparatus according to claim 1, wherein the predetermined condition used for the pixel determined as achromatic is any one of a K monochrome converting condition using a black color and a normal converting condition using cyan, magenta, yellow, and black colors.

5. The image forming apparatus according to claim 1, wherein said obtainer checks pixels in a predetermined area in the original image data to obtain the image property of the pixel.

6. The image forming apparatus according to claim 1, wherein the image property of the pixel is either one of a first image property of including any chromatic pixel in the pixels in the predetermined area and a second property of not including any chromatic pixel in the pixels in the predetermined area, and said converting condition designator designates the K monochrome converting condition to the pixel having the first image property.

7. The image forming apparatus according to claim 1, wherein the predetermined area comprises a predetermined number of sequential pixels immediately preceding the pixel in a main scanning direction.

8. The image forming apparatus according to claim 1, wherein the predetermined area comprises a predetermined number of sequential pixels immediately succeeding the pixel in a main scanning direction.

9. The image forming apparatus according to claim 1, wherein the predetermined area comprises a predetermined number of sequential pixels immediately preceding and succeeding the pixel in a main scanning direction.

10. The image forming apparatus according to claim 1, wherein the predetermined area is formed with an m-by-n matrix surrounding the pixel, m and n being positive integer values greater than zero.

11. An image processing apparatus for generating graphics data according to picture description instructions based on original image data of full color, comprising:
chromatic checking means for checking to determine whether a pixel of the original image data is chromatic or achromatic;
obtaining means for obtaining an image property of the pixel;
color converting means for converting the original image data into CMYK data for printing according to a predetermined converting condition; and
converting condition designating means for designating a type of the predetermined converting condition for the pixel determined as achromatic by said chromatic checking means according to the image property obtained by said obtaining means.

12. The image processing apparatus according to claim 11, wherein said chromatic checking means determines the pixel as achromatic when values of RGB color components are identical to each other.

13. The image processing apparatus according to claim 11, wherein said chromatic checking means determines the pixel as achromatic when differences in data value among RGB components of the pixel fall within respective predetermined threshold values.

14. The image processing apparatus according to claim 11, wherein the predetermined condition applied to the pixel determined as achromatic is any one of a K monochrome converting condition using a black color and a normal converting condition using cyan, magenta, yellow, and black colors.

15. The image forming apparatus according to claim 11, wherein said obtaining means checks pixels in a predetermined area in the original image data to obtain the image property of the pixel.

16. The image forming apparatus according to claim 11, wherein the image property of the pixel is either one of a first image property of including any chromatic pixel in the pixels in the predetermined area and a second property of not including any chromatic pixel in the pixels in the predetermined area, and said converting condition designating means designates the K monochrome converting condition to the pixel having the first image property.

17. The image forming apparatus according to claim 11, wherein the predetermined area comprises a predetermined number of sequential pixels immediately preceding the pixel in a main scanning direction.

18. The image forming apparatus according to claim 11, wherein in the predetermined area comprises a predetermined number of sequential pixels immediately succeeding the pixel in a main scanning direction.

19. The image forming apparatus according to claim 11, wherein the predetermined area comprises a predetermined number of sequential pixels immediately preceding and succeeding the pixel in a main scanning direction.

20. The image forming apparatus according to claim 11, wherein the predetermined area is formed with an m-by-n matrix surrounding the pixel, m and n being positive integer values greater than zero.

21. A graphics data processing method for generating graphics data according to picture description instructions based on original image data of full color, the graphics data processing method comprising the steps of:
determining whether a pixel of the original image data is chromatic or achromatic;
obtaining an image property of the pixel;
designating a type of a predetermined converting condition for the pixel determined as achromatic by said determining step according to the image property obtained in said obtaining step; and
converting the original image data into CMYK data according to the predetermined converting condition.

22. The graphics data processing method according to claim 21, wherein said chromatic checking step determines the pixel as achromatic when values of RGB color components are identical to each other.

23. The graphics data processing method according to claim 21, wherein said chromatic checking step determines the pixel as achromatic when differences in data value among RGB components of the pixel fall within respective predetermined threshold values.

24. The graphics data processing method according to claim 21, wherein the predetermined condition applied to the pixel determined as achromatic is any one of a K monochrome converting condition using a black color and a normal converting condition using cyan, magenta, yellow, and black colors.

25. The graphics data processing method according to claim 21, wherein said obtaining step checks pixels in a predetermined area in the original image data to obtain the image property of the pixel.

26. The graphics data processing method according to claim 21, wherein the image property of the pixel is either one of a first image property of including any chromatic pixel in the pixels in the predetermined area and a second property of not including any chromatic pixel in the pixels in the predetermined area, and said designating step designates the K monochrome converting condition to the pixel having the first image property.

27. The graphics data processing method according to claim 21, wherein the predetermined area comprises a predetermined number of sequential pixels immediately preceding the pixel in a main scanning direction.

28. The graphics data processing method according to claim 21, wherein the predetermined area comprises a predetermined number of sequential pixels immediately succeeding the pixel in a main scanning direction.

29. The graphics data processing method according to claim 21, wherein the predetermined area comprises a predetermined number of sequential pixels immediately preceding and succeeding the pixel in a main scanning direction.

30. The graphics data processing method according to claim 21, wherein the predetermined area is formed with an m-by-n matrix surrounding the pixel, m and n being positive integer values greater than zero.

31. A computer program product stored on a computer readable storage medium for causing a computer to carry out an image processing method, when run on an image processing apparatus, said method comprising the steps of:
chromatic checking to determine whether a pixel of the original image data is chromatic or achromatic;
obtaining an image property of the pixel;
designating a type of a predetermined converting condition for the pixel determined as achromatic in said chromatic checking step according to the image property obtained in said obtaining step; and
converting the original image data into CMYK data for printing according to the predetermined converting condition.

32. The product according to claim 31, wherein said chromatic checking step determines the pixel as achromatic when values of RGB color components are identical to each other.

33. The product according to claim 31, wherein said chromatic checking step determines the pixel as achromatic when differences in data value among RGB components of the pixel fall within respective predetermined threshold values.

34. The product according to claim 31, wherein the predetermined condition applied to the pixel determined as achromatic is any one of a K monochrome converting condition using a black color and a normal converting condition using cyan, magenta, yellow, and black colors.

35. The product according to claim 31, wherein said obtaining step checks pixels in a predetermined area in the original image data to obtain the image property of the pixel.

36. The product according to claim 31, wherein the image property of the pixel is either one of a first image property of including any chromatic pixel in the pixels in the predetermined area and a second property of not including any chromatic pixel in the pixels in the predetermined area, and said designating step designates the K monochrome converting condition to the pixel having the first image property.

37. The product according to claim 31, wherein the predetermined area comprises a predetermined number of sequential pixels immediately preceding the pixel in a main scanning direction.

38. The product according to claim 31, wherein the predetermined area comprises a predetermined number of sequential pixels immediately succeeding the pixel in a main scanning direction.

39. The product according to claim 31, wherein the predetermined area comprises a predetermined number of sequential pixels immediately preceding and succeeding the pixel in a main scanning direction.

40. The product according to claim 31, wherein the predetermined area is formed with an m-by-n matrix surrounding the pixel, m and n being positive integer values greater than zero.

41. A computer readable medium storing computer instructions for causing a computer to perform an image processing method, said method comprising:
chromatic checking to determine whether a pixel of the original image data is chromatic or achromatic;
obtaining an image property of the pixel;
designating a type of a predetermined converting condition for the pixel determined as achromatic in said chromatic checking step according to the image property obtained in said obtaining step; and
converting the original image data into CMYK data for printing according to the predetermined converting condition.

42. The storage medium according to claim 41, wherein said chromatic checking step determines the pixel as achromatic when values of RGB color components are identical to each other.

43. The storage medium according to claim 41, wherein said chromatic checking step determines the pixel as achromatic when differences in data value among RGB components of the pixel fall within respective predetermined threshold values.

44. The storage medium according to claim 41, wherein the predetermined condition applied to the pixel determined as achromatic is any one of a K monochrome converting condition using a black color and a normal converting condition using cyan, magenta, yellow, and black colors.

45. The storage medium according to claim 41, wherein said obtaining step checks pixels in a predetermined area in the original image data to obtain the image property of the pixel.

46. The storage medium according to claim 41, wherein the image property of the pixel is either one of a first image property of including any chromatic pixel in the pixels in the predetermined area and a second property of not including any chromatic pixel in the pixels in the predetermined area, and said designating step designates the K monochrome converting condition to the pixel having the first image property.

47. The storage medium according to claim 41, wherein the predetermined area comprises a predetermined number of sequential pixels immediately preceding the pixel in a main scanning direction.

48. The storage medium according to claim 41, wherein the predetermined area comprises a predetermined number of sequential pixels immediately succeeding the pixel in a main scanning direction.

49. The storage medium according to claim 41, wherein the predetermined area comprises a predetermined number of sequential pixels immediately preceding and succeeding the pixel in a main scanning direction.

50. The storage medium according to claim 41, wherein the predetermined area is formed with an m-by-n matrix surrounding the pixel, m and n being positive integer values greater than zero.

51. A printing apparatus comprising:
a printer engine; and
a printer controller storing a computer program product for carrying out an image processing method, the method comprising the steps of:
chromatic checking to determine whether a pixel of the original image data is chromatic or achromatic;
obtaining an image property of the pixel;
designating a type of a predetermined converting condition for the pixel determined as achromatic in said chromatic checking step according to the image property obtained in said obtaining step; and
converting the original image data into CMYK data for printing according to the predetermined converting condition.

52. A hosting apparatus comprising:
a computer; and
a printer driver installed in said computer and storing a computer program product for carrying out an image processing method, the method comprising the steps of:
chromatic checking to determine whether a pixel of the original image data is chromatic or achromatic;
obtaining an image property of the pixel;
designating a type of a predetermined converting condition for the pixel determined as achromatic in said chromatic checking step according to the image property obtained in said obtaining step; and
converting the original image data into CMYK data for printing according to the predetermined converting condition.
